(19) United States
(12) Patent Application Publication
(10) Pub. No.: US 2004/0262573 A1
(43) Pub. Date: Dec. 30, 2004

(54) Method for forming mixed liquid crystal binary mixture with V-shaped switching

(76) Inventors: Shune-Long Wu, Taipei City (TW); Wen-Jiunn Hsieh, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/602,866

(22) Filed: Jun. 25, 2003

(51) Int. Cl. C09K 19/20; C09K 19/12; C09K 19/52

(52) U.S. Cl. 252/299.65; 252/299.67; 252/299.01

(57) ABSTRACT

The present invention provides a mixed liquid crystal binary mixture with V-shaped switching electro-optical response characteristic, which is produced by achiral swallow-tailed material doped with the antiferroelectric liquid crystal material or with the ferroelectric liquid crystal material. The achiral swallow-tailed compound as the main material that is doped with the antiferroelectric liquid crystal material or with the ferroelectric liquid crystal material to produce the binary mixture, wherein the mixed liquid crystal binary mixture exhibits the electro-optical response of V-shaped switching in the antiferroelectric phase or in the ferroelectric phase.

### BACKGROUND OF THE INVENTION

1. Field of the Invention

The present invention generally relates to a method for forming mixed liquid crystal material, and more particularly to a method for utilizing an achiral swallow-tailed material doped with the antiferroelectric liquid crystal or ferroelectric liquid crystal to generate a binary liquid crystal mixture, such that the binary liquid crystal mixture displayed the v-shaped switching properties in the ferroelectric phase or in antiferroelectric phase.

2. Description of the Prior Art

Thresholdless, V-shaped switching in chiral smectic liquid crystals has become a very attractive subject for research due to the unique properties of these materials for display applications. So far, only two mixtures (Inui and Mitsui mixtures) showing V-shaped switching properties have been reported. The components in the mixtures are generally derived from a homologous series of chiral tail groups with a highly polar trifluoromethyl substituent attached to the chiral center. Consequently, the mixtures possess high polarization, e.g. the maximum Ps values for the Inui mixture is about 170 nC/cm².

Furthermore, the chiral swallow-tailed compound 1-ethylpropyl (S)-2-{6-[4-(4-decyloxyphenyl)benzoyloxy]-2-naphthyl}propionate, (S)-EP10PBNP, as sketched

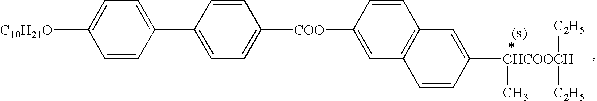

showing an antiferroelectric liquid crystal phase possessing thresholdless, V-shaped switching. The material design was based primarily on a chiral molecule in which a methyl substituent at the chiral center is attached close to the core of the molecule, in conjunction with a swallow-tailed group in the chiral tail. The antiferroelectric phase of this material was found to posses a relatively low polarization (maximum pₛ=30 nC/cm²) as compared with that reported for Inui and Mitsui mixtures.

### SUMMARY OF THE INVENTION

It is an object of this invention to utilize the achiral swallow-tailed compound doped with antiferroelectric liquid crystal to generate a binary antiferrroelectric liquid crystal mixture with V-shaped switching electro-optic response.

It is a further object of this invention is that the electro-optic response of the binary antiferroelectric liquid crystals in the ferroelectric phase displayed V-shaped switching, while that in the antiferroelectric phase displayed a double hysteresis switching.

It is yet another object of this invention to mix the achiral swallow-tailed compounded and ferroelectric liquid crystal material to generate a binary ferroelectric liquid crystals mixtures with V-shaped switching electro-optic response.

According to abovementioned objects, the present invention provides a method for forming a binary liquid crystal mixture with V-shaped switching electro-optic properties. The method comprises an achiral swallow-tailed compound doped with small amount of the antiferroelectric liquid crystal material or with the ferroelectric liquid crystal material to generate a binary liquid crystal mixture, which displayed V-shaped electro-optic response in the ferroelectric phase. The achiral swallow-tailed compound exhibits SmA and SmCₐₗₜ phase, which doped with the antiferroelectric liquid crystal material or with the ferroelectric liquid crystal material resulted in a phase sequence SmA-SmC*-SmA*. The electro-optic response of the binary liquid crystal mixture in the ferroelectric phase displayed V-shaped switching. These optical phenomena implied that a binary mixture containing a larger amount of achiral swallow-tailed material and/or possessing relatively lower polarization favours the occurrence of V-shaped switching in the antiferroelectric phase. Thus, the results of this work also suggested that thresholdless V-shaped switching in chiral smetic liquid crystals could be achieved by mixing an achiral swallow-tailed material with an antiferroelectric liquid crystal.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A through FIG. 1C is a flow chart for showing the preparation of the achiral swallow-tailed compound in accordance with a method disclosed herein;

FIG. 2A through FIG. 2E is a flow chart for showing the preparation of the ferroelectric liquid crystal in accordance with a method disclosed herein;

FIG. 3 a schematic diagram for showing the switching behavior of p15/m85 in the ferroelectric phase (SmC* phase) at 105° C. and the antiferroelectric phase (SmC_{A}* phase) at 95° C. in accordance with a method disclosed herein;

FIG. 4 is a schematic diagram for showing the spontaneous polarization plotted as a function of temperature for the binary mixture p15/m85 and p85/m15 in accordance with a method disclosed herein;

FIG. 5A through FIG. 5F is a schematic diagram for showing the optical transmittance versus electric filed for p15/m85 in a 5 μm homogeneous cell on application of a 1 Hz triangular waveform at 115, 110, and 105° C. of the ferroelectric phase, and at 95, 90, and 85° C. of the antiferroelectric phase (in accordance with a method disclosed herein;

FIG. 6A through FIG. 6F is a schematic diagram for showing the optical transmittance versus filed for p15/m85 in a 5 μm homogeneous cell at various frequencies of the applied triangular waveform at 105° C. in the ferroelectric phase and 95° C. in the antiferroelectric phase in accordance with a method disclosed herein;

FIG. 7A through FIG. 7D is a schematic drawing showing the optical transmittance versus electric field for p85/m15 in a 5 μm homogeneous cell on application of a 1 Hz frequency triangular waveform at several temperatures of the antiferroelectric phase in accordance with a method disclosed herein;

FIG. 8 is a schematic diagram for showing the switching behavior in the ferroelectric phase in different composition of the ferroelectric liquid crystal and the achiral swallow-tailed compound that measured at 30° C. below curie point in homogeneously aligned cells of 5 μm thickness in accordance with a method disclosed herein;

FIG. 9 is a schematic diagram for showing the spontaneous polarization plotted as a function of temperature for binary mixtures of compounds ferroelectric liquid crystal and achiral swallow-tailed compound in accordance with a method disclosed herein;

FIG. 10A through FIG. 10F is a schematic diagram for showing the electro-optic response of transmittance versus electric filed for ferroelectric liquid crystal compound in the ferroelectric phase at several temperatures and frequencies of applied triangular wave in accordance with a method disclosed herein; and

FIG. 11A through FIG. 11F is a schematic diagram for showing the electro-optical response of transmittance versus electric filed for the different composition of the mixtures in the ferroelectric phase at several temperatures and frequencies of applied triangular wave.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

Thresholdless, V-shaped switching in chiral smectic liquid crystals is of great interest, since this type of material is very promising for display applications. So far, only two mixtures showing V-shaped switching properties have been reported. The components in the mixtures are generally derived from a homologous series of chiral tail groups with a highly polar trifluoromethyl substituent attached to the chiral center.

The present invention utilizes the achiral materials with swallow-tailed terminal moieties encourage the formation of an “antiferroelectric-like” phase, a so-called SmCₐₗₜ phase, and can be doped with small quantity of antiferroelectric liquid crystal to induce antiferroelectricity. Therefore, according to above reasons, the achiral swallow-tailed compound doped with antiferroelectric liquid crystal material or achiral swallow-tailed compound with the ferroelectric liquid crystal material to generate binary liquid crystal mixture, and further to explore V-shaped switching phenomena.

The achiral swallow-tailed compound, 2-propylpentyl-4 4′-decyloxybiphenyl-4-carbonyloxy)benzoate, the chemical structure formula is

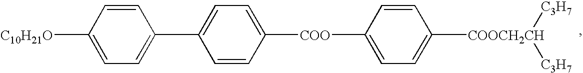

and a well known antiferroelectric liquid crystal, (S)-4-(1 -methylheptyloxy)carbonylphenyl 4′-octyloxy-4-biphenylcarboxylate, the chemical structure formula is

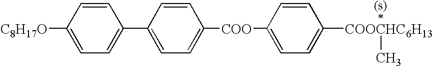

was used for mixing with antiferroelectric liquid crystal material to generate a binary ferroelectric liquid crystal mixture.

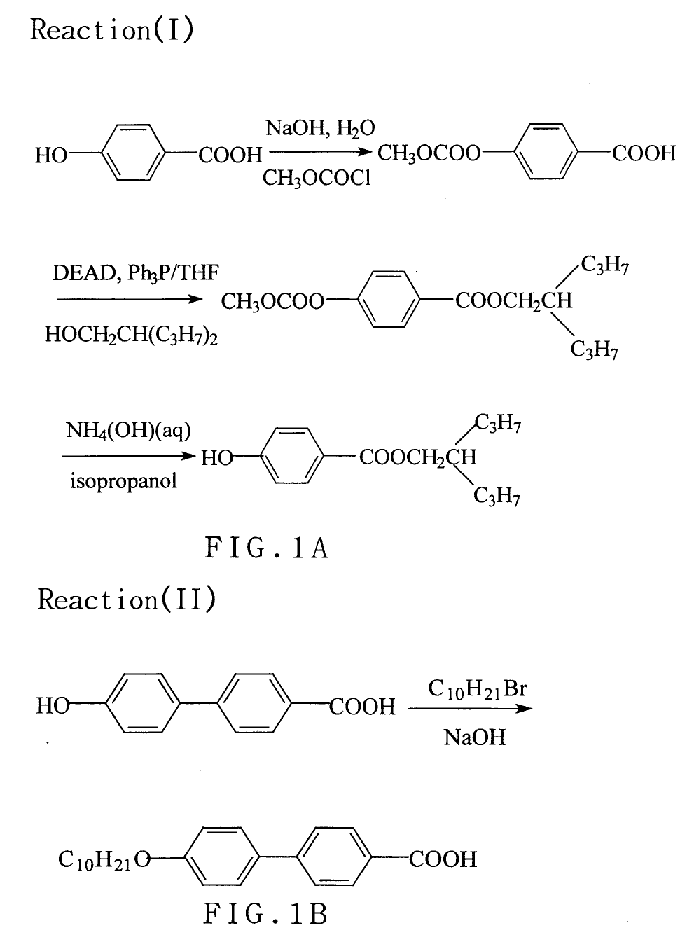

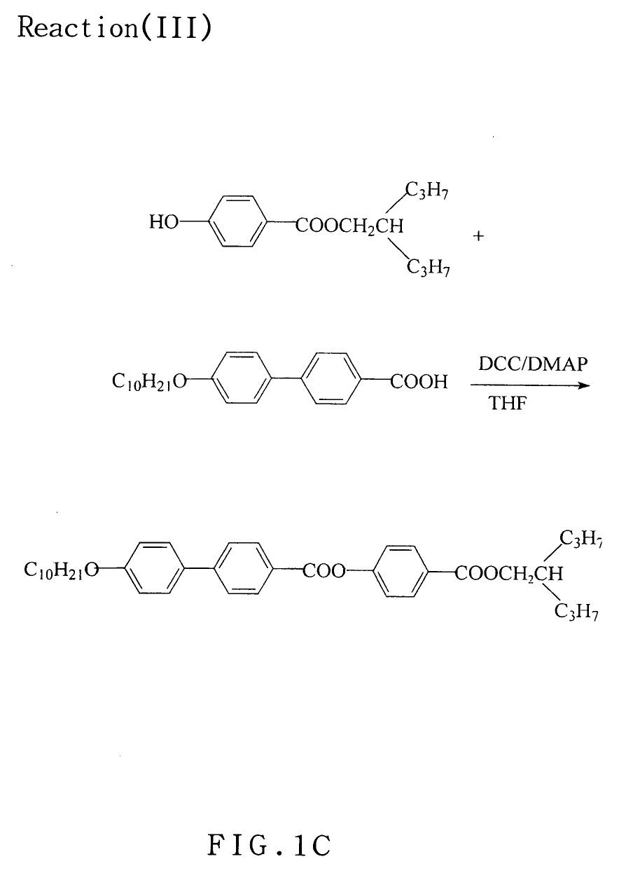

Referring to FIG. 1A through FIG. 1C, showing a flow chart for preparing the achiral swallow-tailed compound for the present invention. The Reaction (I) of the FIG. 1A, methyl chloroforamte was added to 4-hydroxybenzoaic acids in an aqueous sodium hydroxide solution to protect the hydroxyl group, giving 4-methoxy-carbonyloxybenzoic acids. Then, 4-methoxy-carbonyloxybenzoic acids was esterified with 2-propyl-1-pentanol by treatment with triphenylphosphine (Ph₃P) and diethylazodicarboxylate (DEAD) to generate 2-propylpentyl 4-methoxycarbonyloxybenzoate. This benzoate compound was converted to 2-propylpentyl 4-hydroxybenzoate by removing the protecting group with a solution of ammonia in isopropanol.

Next, in the Reaction (II) of the FIG. 1B, esterification of 2-propylpentyl 4-hydroxybenzoate with 4-(4-decyloxyphenyl)benzoic acid, which was prepared previously by the Williamson synthesis involving 4′-hydroxybiphenyl=4carboxylic acid with 1-bromodecane, produced t h e target material, 2-propylpentyl-4-4′-decyloxybiphenyl-4 -carbonyloxy) benzoate as shown in Reaction (III) of FIG. 1C.

In addition, the antiferroelectric liquid crystal (S)-4-[1-metyhyl-heptyloxyl]carbonyl]phenyl 4′-octyloxy-4-biphenyl-carboxylate, (S)-MHPOBC, with 99% purity that was purchased from Aldrich, US, and used directly for preparing mixtures without further purification.

Then, the mixtures were prepared by weight percentage and mixed thoroughly with the addition of anhydrous dichloromethane. The dichloromethane was then evaporated and the mixtures further dried under vacuum. The mixture of p15/m85 refers to the mixture of 85% (S)-MHPOBC doped with 15% 2-propylpentyl-4 4′-decyloxybiphenyl-4-carbonyloxy)benzoate, while that of p85/m15 refers to the mixture of 85% p doped with 15% m.

Furthermore, the alternative preferred embodiment of the present invention, the achiral swallow-tailed compound, 2-propylpentyl 4-(4′-nonyloxybiphenyl-4-carbonyloxy) benzoate, the structure formula is

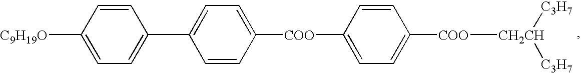

which is doped with ferroelectric liquid crystal material, 1-ethylpropyl (S)-2-[2-fluoro-4-(4′-decyloxybiphenylcarbonyloxybenzoyl)propanoate, the structure formula is

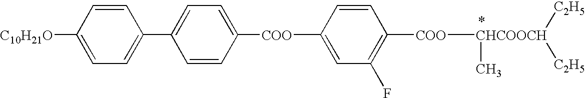

, to generate a binary ferroelectric liquid crystal mixtures. As well as the binary antiferroelectric liquid crystal mixtures, the binary ferroelectric liquid crystal has V-shaped switching electro-optic response.

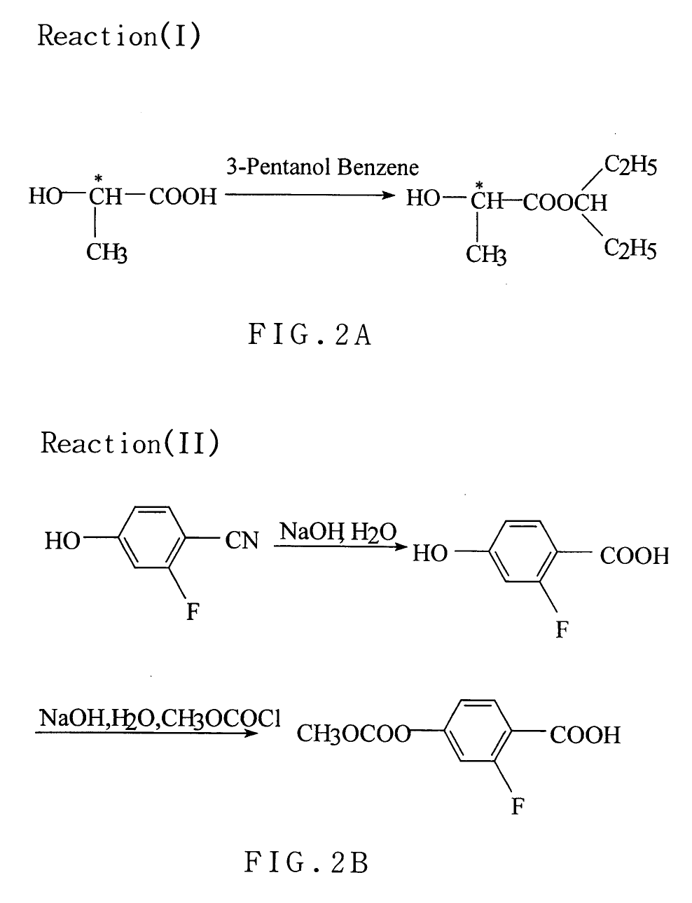

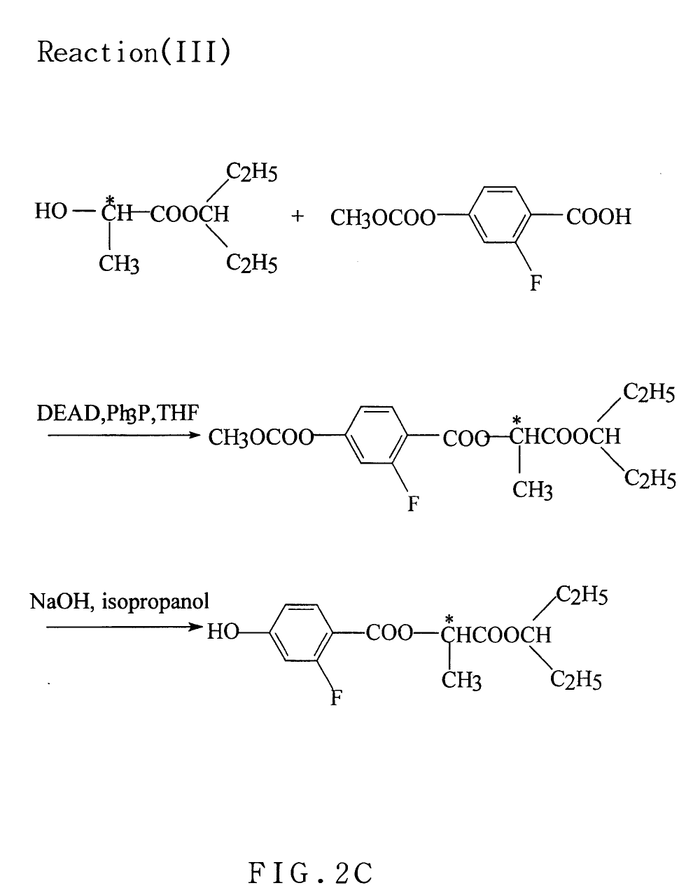

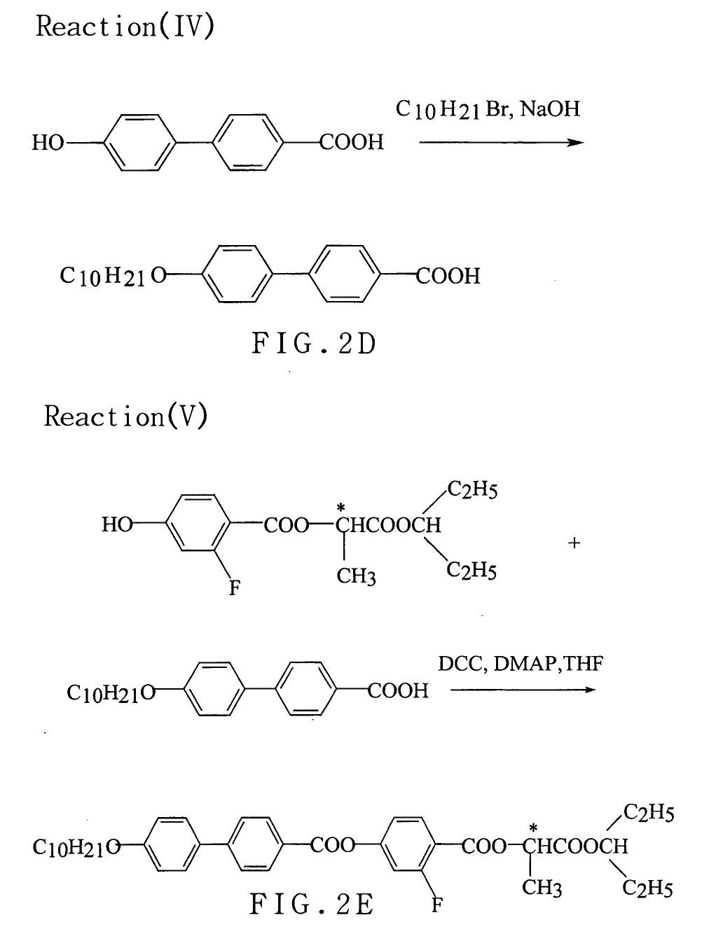

Referring to FIG. 2A through FIG. 2E, which shows the flow chart for the preparation of the ferroelectric liquid crystal material. As shown in Reaction (I) of the FIG. 2A, the (L)-Lactic acid and 2-ethylpropanol were dissolved in dry benzene, and heated under reflux overnight using a Dean-Stark trap to remove water. After removing the benzene solvent, the residue was distilled under vacuum to yield compound, 2-ethylpropyl (S)-Lactate, the structure formula is

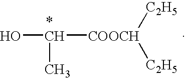

Then, referring to Reaction (II) of FIG. 2B, the 4-Cyano-2-fluorophenol was hydrolyzed by heating under refluxing with sodium hydroxide in water for about two hours. When, cool, the mixture was acidified with concentrated hydrochloric acid, and the solution extracted with diethyl ether was removed and the product crystallized from ethyl acetate/hexane to afford a white crystalline solid, the structure formula is

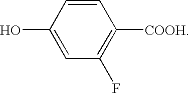

In the Reaction (III) of FIG. 2C, the compound 2-Fluoro-4-(methoxycrbonyloxy)benzoic acid added to a solution of sodium hydroxide in water with vigorous stirring. Methyl chloroformate was then added slowly to the resulting suspension. The resulting slurry was stirred and brought to pH=5 by addition of concentrated hydrochloric acid and water (1:1). The voluminous precipitate was filtered off and recrystallized from ethanol to give a white solid, the white solid is 2-Fluoro-4-(methoxycarbonyloxy)benzoic acid), the structure formula is

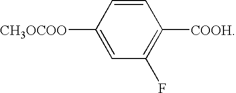

Also referring to Reaction (III), the compound 2-Fluoro-4-(methoxycrbonyloxy)benzoic acid and a solution of diethyl azodicarboxylate (DEAD) in an anhydrous THF that was added drop wise to a solution of triphenylphosphine and compound 2-ethylpropyl (S)-Lactate in anhydrous THF at room temperature with vigorous stirring. The reaction soon started. After standing overnight at room temperature, triphenylphosphine oxide was removed by filtration; THF was then removed under vacuum. After the work-up procedure, the product was by column chromatography over silica gel using ethyl acetate/hexane as eluent, to generate the compound, 1-ethylpropyl (S)-2-[2-fluoro-4-(methoxy-carbonyloxy)benzoyloxy]propanoate as a colourless liquid, the structure formula is

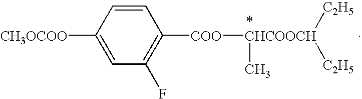

Similarly, in the reaction (III), the compound, 1-ethylpropyl (S)-2-[2-fluoro-4-(methoxy-carbonyloxy)benzoyloxy]propanoate was stirred in a mixture of isopropanol and ammonia at room temperature and then poured into water with stirring.

As referring to Reaction (III), the product was extracted with dichloromethane. The combined extracts were washed with brine, dried (by MgSO₄), filtered and evaporated to give colorless oil. The oil was purified by column chromatography over silica gel using dichloromethane; it was then dried in vacuo to generate the compound, 1-ethylpropyl (S)-2[2-fluoro-4-hydroxy-phenylcarbonyloxy]propanoate, the structure formula is

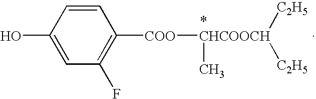

Referring to Reaction (IV) of FIG. 2D, a solution of 4′-hydroxybiphenyl-4-carboxylic acid in ethanol was treated by dropwise addition of a solution of potassium hydroxide and potassium iodide in water. The mixture was heated under reflux about one hour. 1 -Bromodecane was added to the mixture and reflux continued for a further about 12 hours. Aqueous potassium hydroxide was added, and after a further two hours reflux the mixture was acidified with about 5% aqueous HCl and filtered. The crude product was washed with cold water and recrystallized from glacial acetic acid and absolute ethanol, therefore, the compound, 4-(4′-decyloxybiphenyl)benzoic acid can obtain, wherein the structure formula of the 4-(4′-decyloxybiphenyl)benzoic acid is

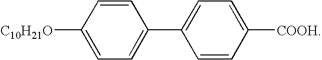

Referring to Reaction (V) of FIG. 2E, a mixture of 4-(4′-decyloxybiphenyl)benzoic acid, 1-ethylpropyl (S)-2-[2-fluoro-4-(methoxy-carbonyloxy)benzoyloxy]propanoate, N,N′-dicyclohexylcarbodiimide, 4-dimethylaminopyrine, and dry THF was stirred at room temperature for three days. The precipitates were filtered off and the filtered washed with 5% acetic acid solution, 5% saturated aqueous sodium hydrogen carbonate and water; it was dried (by MgSO₄) and concentrated in vacuum. The residue was purified by column chromatography over silica gel using ethyl acetate/hexane as eluent. After purification by crystallization from absolute ethanol, a final product was obtained.

Similarly, the forming step of the alternative preferred embodiment is same as well as the above-preferred embodiment of the present invention. The mixtures were prepared by weight percentage and mixed thoroughly with the addition of anhydrous dichloromethane. The dichloromethane was then evaporated and the mixtures further dried under vacuum. The binary mixture obtained are described, for example, as follows: p20/F80 refers to the mixture 20% achiral swallow-tailed compound and 80% ferroelectric liquid crystal material, while p80/F20 refers to the mixture of 80% achiral swallow-tailed compound and 20% ferroelectric liquid crystal material.

According to the embodiments of the present invention that utilized measurement method to determine the properties for the achiral swallow-tailed compound, 2-propylpentyl-4 4′-decyloxybiphenyl-4-carbonyloxy)benzoate, antiferroelectric liquid crystal material, ((S)-4-(1-methylheptyloxy) carbonylphenyl-4′-octyloxy-4-biphenylcarboxylate; (S)-MHPOBC m), and ferroelectric liquid crystal material (1-ethylpropyl (S)-2-[2-fluoro-4-(4′-decyloxybiphenylcarbonyloxybenzoyl)propanoate].

The chemical structure formula of the above materials was analyzed by nuclear magnetic resonance spectroscopy using a Jeol EX-400 FT-NMR spectrometer. The purity of the achiral swallow-tailed compound was checked by thin layer chromatography and further confirmed by elemental analysis using a Perkin-Elmer 2400 spectrometer. Mesophases of the achiral swallow-tailed compound and mixtures were identified principally from microscopic textures of the materials sandwiched between the two glass plates under a polarizing microscope using a Nikon Microphot-FXA in conjunction with an Instec HS 1 heating stage.

The transition temperatures and phase transition enthalpies were determined by differential scanning calorimeter using a Perkin-Elmer DSC7 calorimeter at heating/cooling rates of 1 through 20° C. per minutes. The antiferroelectric phase pf the mixtures was further characterized by switching behavior and electro-optic response in homogeneous cells. The commercially available homogeneous cells coated with polyamide as alignment film were purchased from E.H.C. Co. Japan. The sample was filled into the cell by capillary action in the isotropic state.

Furthermore, the present invention utilizes a method to measure the spontaneous polarization (pₛ) of the mesophases of the material and the mixture. The method comprises a triangular wave method that is applied to the sample from a measurement instrument as a Yogaw AG1200 arbitrary waveform generator to measure the spontaneous polarization. The induced current was displayed by the measuring the voltage across a wire-wound resistor using a Hewlett-Packard HP54502A digital storage oscilloscope.

Then, the binary mixtures were prepared by weight percentage. The binary mixtures p15/m85 refers to the mixture of 85% m doped with 15% p, while that of p85/m15 refers to the mixture of 85% p doped with 15% m. the mesophases of the achiral swallow-tailed compound and the binary mixtures were primarily characterized by their microscopic textures. The achiral material exhibits SmA and SmCₐₗₜ phases. The SmA phase displayed a focal-conic texture. The SmCₐₗₜ phase is characterized by the appearance of a schlieren texture with the presence of a small number of tw-bruch and many four-brush singularities as shown in circles and squares, respectively. The binary mixtures p15/m85 and p85/m15 gave phase sequence SmA*-SmC*-SmC_{A}*, respectively. The SmA* phase showed a focal-conic texture and the ferroelectric phase (SmC* phase) showed a focal-conic texture. The antiferroelectric phase (SmC_{A}* phase) displayed a striated focal-conic texture in the thicker sample region, and was further characterized by the shclieren texture with two-brush and four-brush singularities in the thinner sample region.

In addition, the calorimetry study indicated that the shape of the SmA-SmCₐₗₜ transition peak for the achiral material was clearly first order in nature, supporting the assignment of the SmCₐₗₜ phase. The SmA*-SmC_{A}* transition peak for the mixture p85/m15 displayed a first order characteristic, and indicated the existence of the antiferroelectric phase. The SmA*-SmC* and SmC*-SmC_{A}* transitions for the binary mixture p15/m85 shoed second and weak first order characteristics, respectively. The phase sequence, transition temperatures and corresponding phase transition enthalpies of mesophases for the achiral material and the binary mixtures obtained by DSC 7 (differential scanning calorimeter). The thermal stability of the ferroelectric phase is enhanced in the mixture p15/m85 as compared that of (S)-MHPOBC. The ferroelectric phase seems to be suppressed on increasing the amount of achiral material, as indicated in the mesohpases on going from p15/m85 to p85/m15.

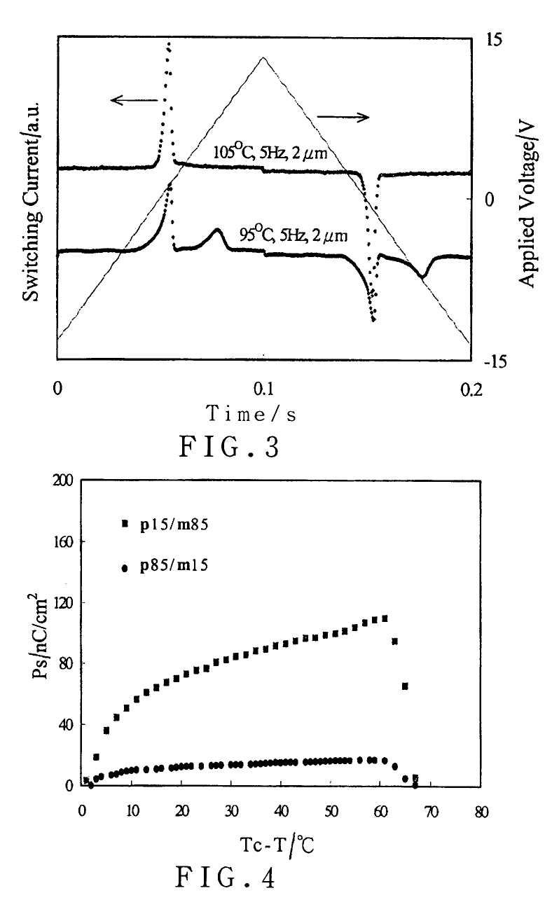

As shown in FIG. 3, the switching current behavior of p15/m85 in the ferroelectric pahse and antiferroelectric phase were investigated in 2 μm homogeneous cells. A single and sharp switching current peak, representing a switching between two ferroelectric states, appears in the whole temperature range of the first ferroelectric phase. In the temperature range of the antiferroelectric phase, two current peaks appears as the characteristics of antiferroelectric-ferroelectric switching among three states, i.e. one stable antiferroelectric state in the absence of an applied electric field and two field-induced ferroelectric states. The switching behavior of p85/m15 in the antiferroelectric phase, displays two current peaks, which are slightly overlapped.

Furthermore, FIG. 4 shows the magnitudes of spontaneous polarization for both mixtures were measured as a function of temperature on cooling in 2 μm homogeneous cells. Therefore, he spontaneous polarization of the binary mixtures increase with decreasing temperature, and the mixture p15/m85 containing the large amount of (S)-MHPOBC displays a higher polarization. The maximum pₛ value in mixture p85/m15 is approximately 17 nC/cm²; that in mixture p15/m85 is approximately 110 nC/cm².

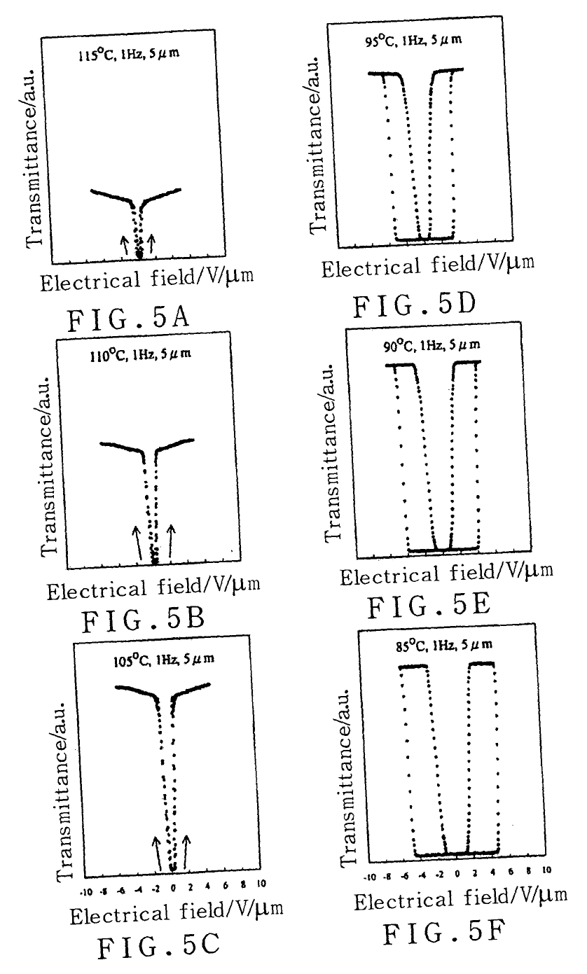

Referring to FIG. 5A through 5F, the optical transmittance versus electric field for p15/m85 in a 5 μm homogeneous cell on application of a 1 Hz triangular wave form at 115, 110, and 105° C. of the ferroelectric phase, and at 95, 90, and 85° C. of the antiferroelectric phase. The electro-optic response of p16/m85 at 1 Hz applied frequency, shows a slight hysteresis at the V-shaped with arrow for the switching directions; this appears in the ferroelectric phase, whereas a double hystersis switching appears in the antiferroelectric phase. The maximum value of optical transmittance in V-shaped switching significantly increases with decreasing temperature in the SmC* phase due to the increasing tilt angle.

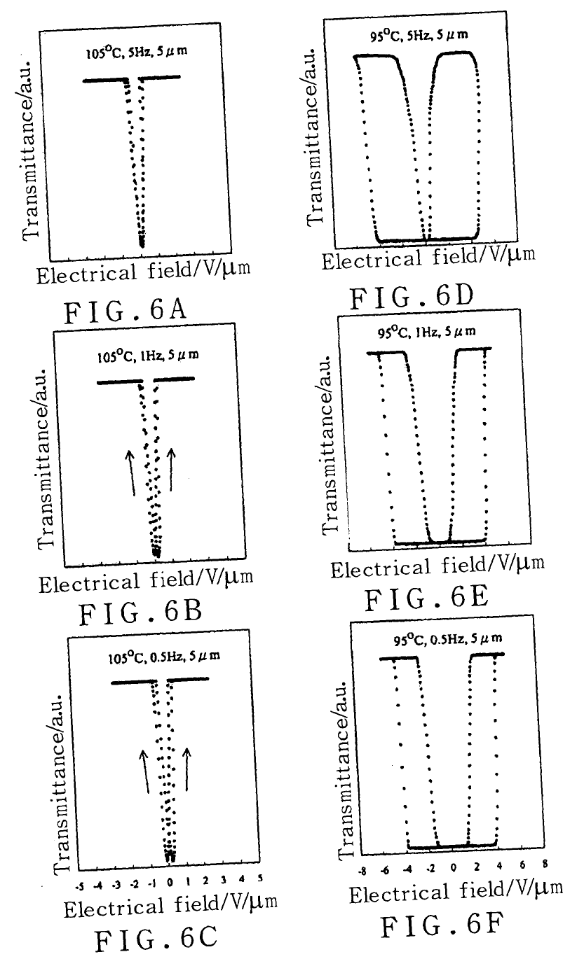

The hysteresis and W-shaped switching in the SmC* phase can be confined to a V-shaped as indicated in FIG. 6A through FIG. 6F as 5 Hz of applied frequency. As the frequency decreases from 5 to 0.5 Hz, the first V-shaped switching in the first ferroelectric phase alters to W-shaped switching, bit double hysteresis switching in the antiferroelectric phase remains, although the width of the hysteresis becomes narrower.

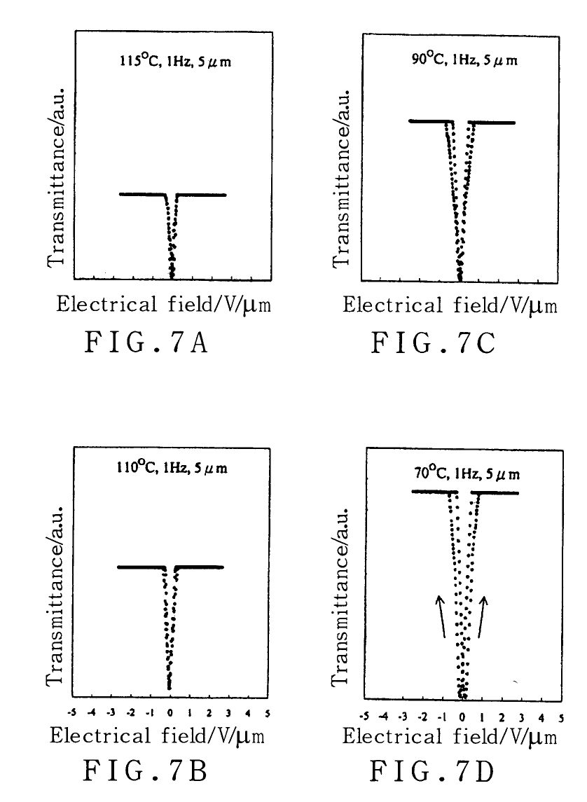

Then, the electro-optic response of p85/m15 at 1 Hz applied frequency, as presented in FIG. 7A through 7D, shows the first V-shaped switching in the vicinity of the SmA*-SmC_{A}* phase transition temperature. This followed by the appearance of a hystersis and W-shaped switching at lower temperatures. However, it is worth pointing out again that this hysteresis and W-shaped switching may be confined to the first V-shaped switching by changing the applied frequency and/or the thickness of the homogeneous cell.

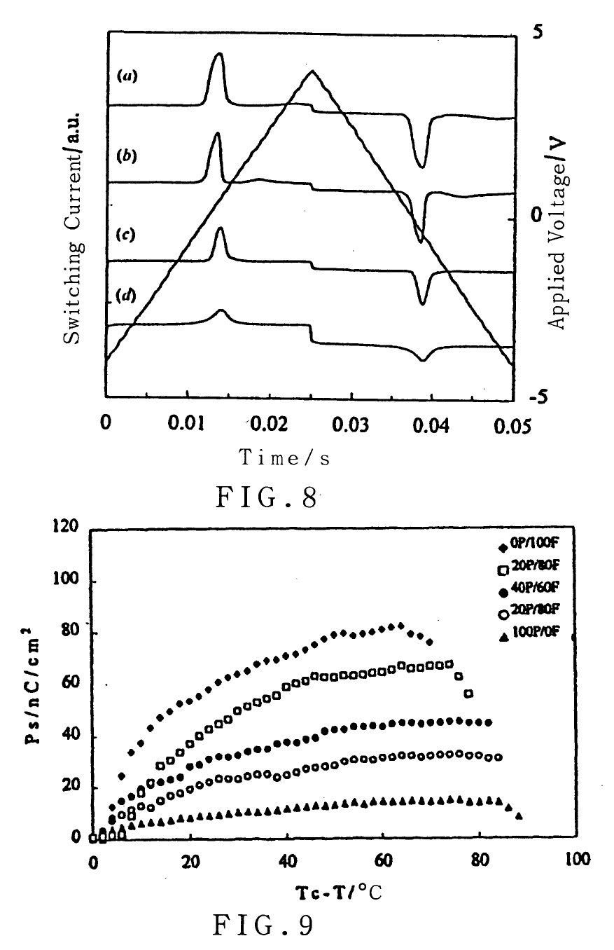

According to another preferred embodiment of the present invention, the switching currents measured for compound ferroelectric liquid crystal and each mixture display only one peak, supporting the assignment of a second ferroelectric phase as indicated in FIG. 8. In order to obtain a unit domain of surface-stabilized geometry for the ferroelectric compound and the mixture in the cells, a variable frequency a.u. electric field (f=0.5 Hz through 2.5 kHz, E=10 through 20 Vpp wave form: triangular wave) was applied to the cells during cooling. The strength of these current peaks slightly decreases with increasing amount of achiral swallow-tailed, but the relative position of the peaks is almost unchanged.

Referring to FIG. 9, which shows some representative results of spontaneous polarization pₛ as a function of temperature measured for ferroelectric liquid crystal and binary mixtures. The maximum Ps value for compound ferroelectric liquid crystal is approximates 82 nC/cm². The maximum pₛ value decreases as the amount of achiral material increases.

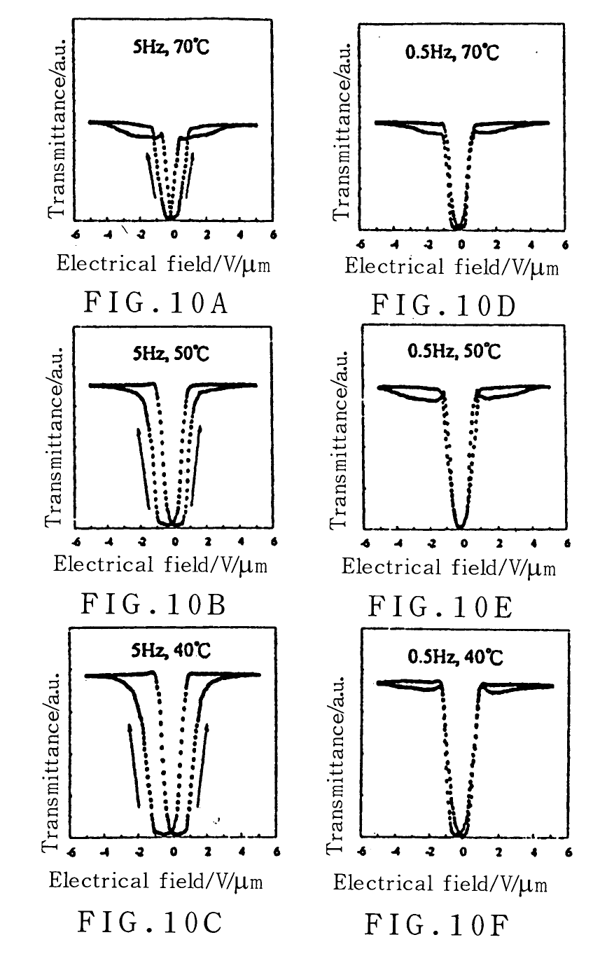

Referring to FIG. 10A through FIG. 10F, which illustrates the electro-optical response of transmittance versus electric field for second compound ferroelectric in the ferroelectric phase at several temperatures and frequencies of applied triangular wave. The responses critically depended on temperature and frequency. As the temperature decreases, the maximum transmittance values increases due to the increase of the tilt angle. At 5 Hz applied frequency, the characteristic ferroelectric hysteresis loop appears in the temperature region of the second ferroelectric phase. However, as the applied frequency is lowered to 0.5 Hz, hysteresis-free, U-shaped switching is seen, as shown in the switching response at 0.5 Hz and 50° C. Thus, the optical responses in the second ferroelectric phase essentially depend on the applied frequency.

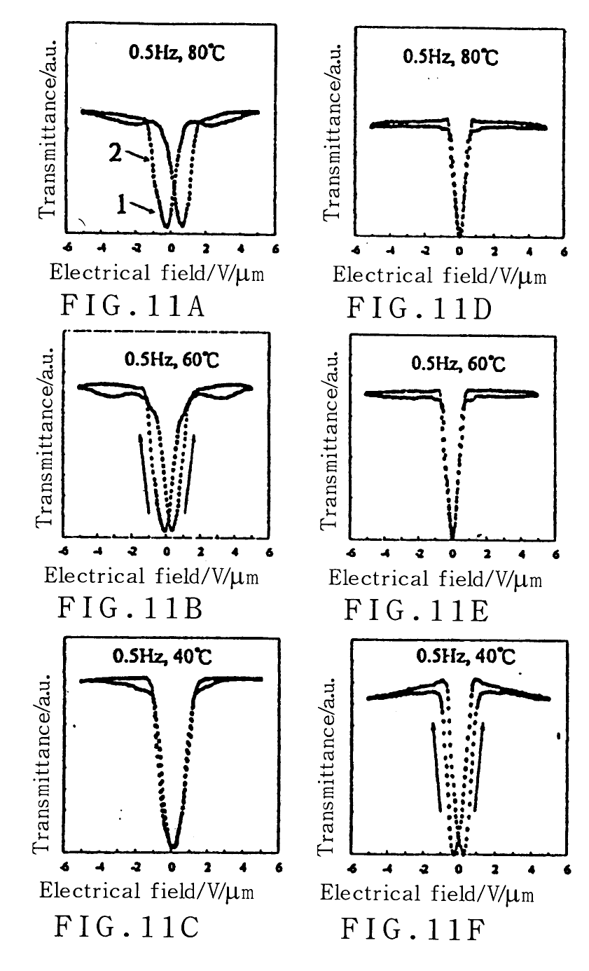

Then, FIG. 11A through FIG. 11F show the electro-optic responses that obtained for two mixtures at 0.5 Hz applied frequency and various temperatures in 5 μm homogeneous cells. In the mixture p20/F80, the hysteresis loop appears different from that observed in a normal ferroelectric phase. As can be seen from the hysteresis loop at 80° C., the optical response appears W-shaped near the minimum (arrow 1), while the rest of the hysteresis loop retains its ferroelectric nature (arrow 2). However, as the temperature is cooled to 60° C., a typical W-shaped switching appears. Further cooling to 40° C. gives a thresholdless, second V-shaped switching. On increasing the amount of achiral swallow-tailed compound, as the in mixture p40/F60, second V-shaped switching is observed at 80 and 60° C. in the second ferroelectric phase.

A W-shaped features occurs at 40° C., which can alter to second V-shaped switching on changing the applied frequency or the cell thickness. The mixtures containing higher amount of achiral swallow-tailed compound, gave similar results to those of p40/F60.

These optical phenomena suggest that second V-shaped switching in ferroelectric mixtures can be achieved by mixing a ferroelectric liquid crystal with an achiral swallow-tailed material. The increasing amount of achiral swallow-tailed in the ferroelectric mixtures results in a decrease of polarization, also implying that low polarization of the ferroelectric mixtures leads to thresholdless, second V-shaped switching. This phenomena is in agreement with previous observation of the appearance of V-shaped switching in an antiferroelectric liquid crystal (S)-EP10PBNP with low polarization, and in antiferroelectric mixtures of (S)-MHPOBC with an achiral swallow-tailed material.

According to above-mentioned, the two binary liquid crystal mixtures can obtain from the achiral swallow-tailed compound doped with the anti0ferroelectric liquid crystal material, and displayed V-shaped switching optic-electro response in ferroelectric phase, and a double hysteresis phenomena in antiferroelectric phase; furthermore, the other binary liquid crystal mixture is obtained from the achiral swallow-tailed and ferroelectric liquid crystal material can display a V-shaped switching optic-electro response in ferroelectric phase.

Although specific embodiments have been illustrated and described, it will be obvious to those skilled in the art that various modifications may be made without departing from what is intended to be limited solely by the appended claims.

1-11. (cancelled).

12. A method for forming a binary liquid crystal mixture with a V-shaped switching electro-optic response, said method comprising:
providing an achiral swallow-tailed compound; and
doping a ferroelectric liquid crystal material with said achiral swallow-tailed compound to generate a binary ferroelectric liquid crystal mixture, wherein said binary ferroelectric liquid crystal mixture with a ferroelectric phase, and displaying a V-shaped switching electro-optic response in said ferroelectric phase.

13. The method according to claim 12, wherein said achiral swallow-tailed compound comprises 2-propylpentyl 4-(4′-nonyloxybiphenyl-4-carbonyloxy) benzoate.

14. The method according to claim 12, wherein said ferroelectric liquid crystal material comprises 1-ethylpropyl (S)-2-[2-fluoro-4-(4′-decyloxybiphenylcarbonyloxybenzoyl)propanoate.

15. A method for forming a binary liquid crystal mixture with V-shaped switching electro-optic response, said method comprising:
providing an achiral swallow-tailed compound; and
doping a liquid crystal material with said achiral swallow-tailed compound to generate a binary liquid crystal mixture, wherein said binary liquid crystal mixture with a phase and displaying a V-shaped switching electro-optic response in said phase.

16. The method according to claim 15, wherein said achiral swallow-tailed compound is 2-propylpentyl-4 (4′-decyloxybiphenyl-4-carbonyloxy)benzoate.

17. The method according to claim 15, wherein said achrial swallow-tailed compound is 2-propylpentyl 4-(4′-nonyloxybiphenyl-4-carbonyloxy)benzoate.

18. The method according to claim 15, wherein said liquid crystal material is a ferroelectric liquid crystal material.

19. The method according to claim 18, wherein said ferroelectric liquid crystal material is 1-ethylpropyl (S)-2-[2-fluoro-4-(4′-decyloxybiphenylcarbonyloxybenzoyl)propanoate.

20. The method according to claim 15, wherein said liquid crystal material is an antiferroelectric liquid crystal material.

21. The method according to claim 20, wherein said antiferroelectric liquid crystal material is (S)-4-(1-methylheptyloxy)carbonylphenyl 4′-octyloxy-4-biphenylcarboxylate.

22. The method according to claim 15, wherein said binary liquid crystal mixture is a binary ferroelectric liquid crystal mixture.

23. The method according to claim 15, wherein said binary liquid crystal mixture is a binary antiferroelectric liquid crystal mixture.

24. The method according to claim 15, wherein said phase is a ferroelectric phase.

25. The method according to claim 15, wherein said phase is an antiferroelectric phase.
